(19) United States
(12) Patent Application Publication
(10) Pub. No.: US 2024/0133008 A1
(43) Pub. Date: Apr. 25, 2024

(54) Amorphous Alloy Soft Magnetic Powder, Dust Core, Magnetic Element, And Electronic Device

(71) Applicant: SEIKO EPSON CORPORATION, Tokyo (JP)

(72) Inventors: Atsushi NAKAMURA, Hachinohe (JP); Takuma ENOMOTO, Hachinohe (JP); Kai KITAMURA, Hachinohe (JP); Junya ABE, Hachinohe (JP); Masayuki OMOTO, Chino (JP)

(21) Appl. No.: 18/358,154

(22) Filed: Jul. 24, 2023

(30) Foreign Application Priority Data
Jul. 25, 2022 (JP) 2022-118565

(51) Int. Cl. C22C 45/02; H01F 1/153; H01F 27/255

(52) U.S. Cl. CPC C22C 45/02; H01F 1/1535; H01F 27/255; C22C 2200/02; C22C 2202/02

(57) ABSTRACT

An amorphous alloy soft magnetic powder contains a particle having a composition with a compositional formula (Fe₁₋ₓCrₓ) a (Si_{1-y}B_{y})_{100-a-b}C_{b} expressed by an atomic ratio, in which 0<x≤0.06, 0.3≤y≤0.7, 70.0≤a≤81.0, and 0<b≤3.0, and when XAFS measurement is performed with an analysis depth set to a bulk, an obtained Fe—K absorption edge XANES spectrum has a first absorption edge structure having a peak A present in a range of 7113±1 eV and a first continuous band structure positioned at a higher energy side than the first absorption edge structure, and an intensity of the peak A at 7113 eV is 0.60 or more and 0.90 or less when an intensity of the first continuous band structure is 1.

The present application is based on, and claims priority from JP Application Serial Number 2022-118565, filed Jul. 26, 2022, the disclosure of which is hereby incorporated by reference herein in its entirety.

### BACKGROUND

### 1. Technical Field

The present disclosure relates to an amorphous alloy soft magnetic powder, a dust core, a magnetic element, and an electronic device.

### 2. Related Art

JP-A-2020-070468 discloses a soft magnetic alloy powder having a main component with a compositional formula (Fe_{(1-(α+β)})X1_{α}X2_{β})_{(1-(a+b+c+d+e+f))}MₐB_{b}P_{c}Si_{d}CₑS_{f}, in which X1 is one or more elements selected from the group consisting of Co and Ni, X2 is one or more elements selected from the group consisting of Al, Mn, Ag, Zn, Sn, As, Sb, Cu, Cr, Bi, N, O, and rare earth elements, M is one or more elements selected from the group consisting of Nb, Hf, Zr, Ta, Mo, W, Ti, and V, 0≤a≤0.160, 0.020≤b≤0.200, 0≤c≤0.150, 0≤d≤0.060, 0≤e≤0.030, 0.0010≤f≤0.030, 0.005≤f/b≤1.50, α≥0, β≥0, and 0≤α+β≤0.50. It is disclosed that, according to such a configuration, a soft magnetic alloy powder having excellent soft magnetic properties and a low coercive force can be obtained.

JP-A-2020-070468 discloses that the soft magnetic alloy powder formed of an amorphous phase can be obtained when a powder body is prepared by an atomization method and then a heat treatment is not performed.

### SUMMARY

However, the soft magnetic alloy powder disclosed in JP-A-2020-070468 still has room for improvement in terms of achieving both a high magnetic permeability and a low coercive force. Specifically, when the magnetic permeability is increased in a soft magnetic powder, it tends to be difficult to sufficiently decrease a coercive force. Therefore, it is an object of the present disclosure to implement a soft magnetic powder which achieves both a high magnetic permeability and a low coercive force.

An amorphous alloy soft magnetic powder according to an application example of the present disclosure contains:
a particle having a composition with a compositional formula (Fe₁₋ₓCrₓ)ₐ(Si_{1-y}B_{y})_{100-a-b}C_{b} expressed by an atomic ratio, in which
0<x≤0.06
0.3≤y≤0.7
70.0≤a≤81.0, and
0<b≤3.0, in which
when XAFS measurement is performed on the particle with an analysis depth set to a bulk, an obtained Fe—K absorption edge XANES spectrum has a first absorption edge structure having a peak A having an energy in a range of 7113±1 eV and a first continuous band structure positioned at a higher energy side than the first absorption edge structure, and
an intensity of the peak A at an energy of 7113 eV is 0.60 or more and 0.90 or less when an intensity of the first continuous band structure is 1.

A dust core according to an application example of the present disclosure contains the amorphous alloy soft magnetic powder according to the application example of the present disclosure.

A magnetic element according to an application example of the present disclosure includes the dust core according to the application example of the present disclosure.

An electronic device according to an application example of the present disclosure includes the magnetic element according to the application example of the present disclosure.

### BRIEF DESCRIPTION OF THE DRAWINGS

FIG. 1 is a longitudinal sectional view showing an example of a device for manufacturing an amorphous alloy soft magnetic powder by a rotary water atomization method.

FIG. 2 is a plan view schematically showing a toroidal type coil component.

FIG. 3 is a transparent perspective view schematically showing a closed magnetic circuit type coil component.

FIG. 4 is a perspective view showing a mobile personal computer which is an electronic device including a magnetic element according to an embodiment.

FIG. 5 is a plan view showing a smartphone which is an electronic device including the magnetic element according to the embodiment.

FIG. 6 is a perspective view showing a digital still camera which is an electronic device including the magnetic element according to the embodiment.

FIG. 7 shows Fe—K absorption edge XANES spectrums obtained by setting an analysis depth to a bulk for amorphous alloy soft magnetic powders in Sample No. 1 (Example) and Sample No. 15 (Comparative Example).

FIG. 8 shows Fe—K absorption edge XANES spectrums obtained by setting the analysis depth to a surface for the amorphous alloy soft magnetic powders in Sample No. 1 (Example) and Sample No. 15 (Comparative Example).

FIG. 9 shows radial distribution functions based on Fe—K absorption edge EXAFS spectrums obtained by setting the analysis depth to a bulk for the amorphous alloy soft magnetic powders in Sample No. 1 (Example) and Sample No. 15 (Comparative Example).

FIG. 10 shows radial distribution functions based on Fe—K absorption edge EXAFS spectrums obtained by setting the analysis depth to a surface for the amorphous alloy soft magnetic powders in Sample No. 1 (Example) and Sample No. 15 (Comparative Example).

FIG. 11 shows X-ray diffraction profiles obtained by an X-ray diffractometer for the amorphous alloy soft magnetic powders in Sample No. 1 (Example) and Sample No. 15 (Comparative Example).

### DESCRIPTION OF EMBODIMENTS

Hereinafter, an amorphous alloy soft magnetic powder, a dust core, a magnetic element, and an electronic device according to the present disclosure will be described in detail based on a preferred embodiment shown in the accompanying drawings.

### 1. Amorphous Alloy Soft Magnetic Powder

An amorphous alloy soft magnetic powder according to an embodiment is an amorphous alloy powder exhibiting soft magnetism. The amorphous alloy soft magnetic powder can be applied to any use, and is formed by, for example, binding particles to each other. Accordingly, a dust core to be used in a magnetic element is obtained.

The amorphous alloy soft magnetic powder according to the embodiment is a powder containing particles having a composition with a compositional formula (Fe₁₋ₓCrₓ)ₐ(Si_{1-y}B_{y})_{100-a-b}C_{b} expressed by an atomic ratio (where 0<x≤0.06, 0.3≤y≤0.7, 70.0≤a≤81.0, and 0<b≤3.0).

When XAFS measurement is performed on a particle with an analysis depth set to a bulk, an obtained Fe—K absorption edge XANES spectrum has a first absorption edge structure having a peak A having an energy in a range of 7113±1 eV and a first continuous band structure positioned at a higher energy side than the first absorption edge structure. An intensity of the peak A at an energy of 7113 eV is 0.60 or more and 0.90 or less when an intensity of the first continuous band structure is 1.

Such an amorphous alloy soft magnetic powder achieves both a high magnetic permeability and a low coercive force. Therefore, by using the amorphous alloy soft magnetic powder, a size of the magnetic element can be reduced and an output of the magnetic element can be increased.

### 1.1. Composition

The composition of the amorphous alloy soft magnetic powder will be described in detail below. As described above, the amorphous alloy soft magnetic powder according to the embodiment has a composition represented by the compositional formula (Fe₁₋ₓCrₓ)ₐ(Si_{1-y}B_{y})_{100-a-b}C_{b}. This compositional formula represents a proportion of the number of atoms in a composition containing five elements, which are Fe, Cr, Si, B, and C.

Fe (iron) greatly affects basic magnetic properties and mechanical properties of the amorphous alloy soft magnetic powder according to the embodiment.

A content rate of Fe is not particularly limited, and is set such that Fe is a main component, that is, a proportion of the number of atoms is the highest in the amorphous alloy soft magnetic powder. In the amorphous alloy soft magnetic powder according to the embodiment, the content rate of Fe is preferably 70.0 atomic % or more and 78.0 atomic % or less, more preferably 71.0 atomic % or more and 77.0 atomic % or less, and still more preferably 72.0 atomic % or more and 75.0 atomic % or less. When the content rate of Fe goes below the above lower limit value, the magnetic permeability of the amorphous alloy soft magnetic powder may decrease depending on the composition. On the other hand, when the content rate of Fe exceeds the above upper limit value, it may be difficult to stably form an amorphous structure depending on the composition.

Cr (chromium) acts to improve corrosion resistance of the amorphous alloy soft magnetic powder. By improving the corrosion resistance, oxidation of the particle is reduced, and decrease of magnetic properties due to the oxidation can be suppressed. A passive state film also contributes to enhancing insulating properties of the particle and reducing an eddy current loss of the magnetic element.

When setting a total number of atoms of the number of Fe atoms and the number of Cr atoms to 1, x represents a proportion of the number of Cr atoms to the total number of atoms. In the amorphous alloy soft magnetic powder according to the embodiment, 0<x≤0.06. It is preferably 0.01≤x≤0.05, and more preferably 0.02≤x≤0.04. When x goes below the above lower limit value, the corrosion resistance decreases. On the other hand, when x exceeds the above upper limit value, the magnetic properties decrease.

a represents a total proportion of Fe and Cr, and is 70.0≤a≤81.0, preferably 73.0≤a≤80.0, and more preferably 75.0≤a≤77.0. When a goes below the above lower limit value, the magnetic properties or the corrosion resistance decrease. On the other hand, when a exceeds the above upper limit value, the amorphous alloy soft magnetic powder is easily crystallized during manufacturing.

When the amorphous alloy soft magnetic powder is manufactured from a raw material, Si (silicon) promotes amorphization and increases the magnetic permeability of the amorphous alloy soft magnetic powder. Accordingly, a high magnetic permeability and a low coercive force can be achieved.

B (boron) promotes amorphization when the amorphous alloy soft magnetic powder is manufactured from the raw material. In particular, by using Si and B in combination, amorphization can be synergistically promoted based on a difference in an atomic radius between Si and B. Accordingly, a high magnetic permeability and a low coercive force can be sufficiently achieved.

When setting a total number of atoms of the number of Si atoms and the number of B atoms to 1, y represents a proportion of the number of B atoms to the total number of atoms. In the amorphous alloy soft magnetic powder according to the embodiment, 0.3≤y≤0.7, and preferably 0.4≤y≤0.6. Accordingly, a balance between the number of Si atoms and the number of B atoms can be optimized. When y goes below the above lower limit value or exceeds the above upper limit value, the balance between the number of Si atoms and the number of B atoms is lost. Therefore, for example, when a proportion of Fe is increased to improve the magnetic properties, amorphization becomes difficult.

A content rate of Si is preferably 8.0 atomic % or more and 13.5 atomic % or less, and more preferably 10.5 atomic % or more and 12.0 atomic % or less.

A content rate of B is preferably 8.0 atomic % or more and 13.5 atomic % or less, and more preferably 10.5 atomic % or more and 12.0 atomic % or less.

C (carbon) reduces a viscosity of a melt when a raw material for the amorphous alloy soft magnetic powder is melted, and facilitates amorphization and pulverization. Accordingly, an amorphous alloy soft magnetic powder having a small diameter and a high magnetic permeability can be obtained. As a result, an eddy current loss can be reduced even in a high-frequency range.

b represents a content rate of C, and is 0<b≤3.0, preferably 1.0≤b≤2.8, and more preferably 1.5≤b≤2.5. When b goes below the above lower limit value, the viscosity of the melt does not sufficiently decrease, and a shape of the particle becomes irregular. Therefore, filling properties during compaction decrease, and a saturation magnetic flux density and a magnetic permeability of a green compact may not be sufficiently increased. On the other hand, when b exceeds the above upper limit value, the amorphous alloy soft magnetic powder is easily crystallized during manufacturing.

The amorphous alloy soft magnetic powder according to the embodiment may contain a trace amount of additive elements in addition to the composition represented by the compositional formula (Fe₁₋ₓCrₓ)ₐ(Si_{1-y}B_{y})_{100-a-b}C_{b} as described above. Examples of the additive elements in a trace amount include S (sulfur) and P (phosphorus). By including these additive elements, the viscosity of the melt can be particularly decreased. As a result, the particle can be made spherical, and the filling properties can be enhanced. These elements are metalloid elements, and contribute to improvement of amorphous formability. Therefore, by containing these additive elements, an amorphous alloy soft magnetic powder capable of obtaining a spectrum having the above features can be easily obtained. Such an amorphous alloy soft magnetic powder has a high degree of amorphization even when the content rate of Fe is high, and can achieve both a high magnetic permeability and a low coercive force.

A content rate of S is not particularly limited, and is preferably 0.0010 mass % or more and 0.0100 mass % or less, more preferably 0.0015 mass % or more and 0.0080 mass % or less, and still more preferably 0.0040 mass % or more and 0.0070 mass % or less. When the content rate of S goes below the above lower limit value, an effect of promoting spheroidization or improving amorphous formability may not be sufficiently obtained. On the other hand, when the content rate of S exceeds the above upper limit value, an addition amount becomes excessive, and promotion of the spheroidization and improvement of the amorphous formability may be inhibited.

A content rate of P is not particularly limited, and is preferably 0.0010 mass % or more and 0.0200 mass % or less, more preferably 0.0015 mass % or more and 0.0180 mass % or less, and still more preferably 0.0050 mass % or more and 0.0150 mass % or less. When the content rate of P goes below the above lower limit value, the effect of promoting the spheroidization or improving the amorphous formability may not be sufficiently obtained. On the other hand, when the content rate of P exceeds the above upper limit value, an addition amount becomes excessive, and promotion of the spheroidization and improvement of the amorphous formability may be inhibited.

By adding both S and P, the amorphous formability can be particularly enhanced. In this case, a ratio S/P of a content of S to a content of P is preferably 0.2 or more and 0.8 or less, and more preferably 0.3 or more and 0.6 or less. By setting S/P within the above range, it is possible to promote the spheroidization and improve the amorphous formability while reducing the content of S and the content of P. That is, by reducing the content, it is possible to suppress a decrease in the magnetic properties of the amorphous alloy soft magnetic powder, and it is also possible to suppress a decrease in a degree of amorphization.

The amorphous alloy soft magnetic powder according to the embodiment may contain, in addition to the elements described above, other elements regardless of an additive element or an impurity. A total content rate of the other elements is preferably 1.0 mass % or less, more preferably 0.2 mass % or less, and still more preferably 0.1 mass % or less. When the content rate is within this range, an effect of the present disclosure is hardly inhibited by the other elements, so that containing of the other elements is acceptable.

The composition of the amorphous alloy soft magnetic powder according to the embodiment is described in detail above, and the composition and impurities are specified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specific examples thereof include a solid emission spectrometer manufactured by SPECTRO, in particular, a spark discharge emission spectrometer, model: SPECTROLAB, type: LAVMB08A, or ICP apparatus CIROS120 type manufactured by Rigaku Corporation.

In particular, when specifying C (carbon) and S (sulfur), a combustion in a current of oxygen (combustion in high frequency induction furnace)-an infrared absorption method defined in JIS G 1211:2011 is also used. Specific examples thereof include a carbon-sulfur analyzer CS-200 manufactured by LECO Corporation.

In particular, when N (nitrogen) and O (oxygen) are specified, an iron and steel-nitrogen determination method defined in JIS G 1228:1997 and general rules for oxygen determination method in metallic materials defined in JIS Z 2613:2006 are also used. Specific examples thereof include an oxygen-nitrogen analyzer, TC-300/EF-300 manufactured by LECO Corporation.

### 1.2. Evaluation of Powder by XAFS Measurement

When XAFS measurement is performed on the particle constituting the amorphous alloy soft magnetic powder according to the embodiment, an X-ray absorption spectrum is obtained. The XAFS measurement is X-ray absorption fine structure measurement, and is an analysis method for examining a chemical state or a local structure of an element in a particle based on X-ray absorption unique to each element. In the XAFS measurement, an X-ray absorption near edge structure (XANES) spectrum and an extended X-ray absorption fine structure (EXAFS) spectrum can be acquired. Based on the XANES spectrum, a chemical state (electronic state) such as a valence of an absorption atom is mainly obtained. Based on the EXAFS spectrum, a local structure (coordination environment) around the absorption atom is mainly obtained.

### 1.2.1. Feature (1)

When XAFS measurement is performed on the particle with an analysis depth set to a bulk, an obtained Fe—K absorption edge XANES spectrum has, as a feature (1), a first absorption edge structure st1 having the peak A and a first continuous band structure st2 positioned at a higher energy side than the first absorption edge structure st1. The peak A has an energy in a range of 7113±1 eV, and satisfies the following intensity ratio. The intensity of the peak A at an energy of 7113 eV is 0.60 or more and 0.90 or less when an intensity of the first continuous band structure st2 is 1.

Satisfying such a feature (1) indicates that a degree of amorphization of the particle is high. It is considered that the peak A corresponds to transition from a is orbit to a dp hybrid orbit by electrons of Fe absorbing an X-ray energy. This transition is considered to occur more easily as the degree of amorphization increases. Therefore, it is considered that the feature (1) reflects a state where atoms are sufficiently randomly arranged even when the content rate of Fe is increased, for example. Accordingly, an amorphous alloy soft magnetic powder satisfying the feature (1) has a high degree of amorphization even when the content rate of Fe is high, and can achieve both a high magnetic permeability and a low coercive force. The XANES spectrum having the feature (1) is a spectrum obtained by setting the analysis depth to a bulk, supporting that the entire particle has a high degree of amorphization.

When the intensity of the peak A goes below the above lower limit value, randomness of atomic arrangement decreases and magnetization reversal hardly occurs, so that the coercive force increases. On the other hand, when the intensity of the peak A exceeds the above upper limit value, a deviation from a peak shape specific to a metal occurs, and the magnetic properties such as a magnetic permeability and a saturation magnetic flux density are likely to decrease.

The above Fe—K absorption edge XANES spectrum is a spectrum obtained by setting the analysis depth for the particle to a bulk (about several 10 μm in depth). Specifically, when an X-ray is selected as a signal to be detected, a depth of the measurement can be set to a bulk, and when an electron is selected as a signal to be detected, the depth of the measurement can be set to a surface. The “intensity of a peak” in the XANES spectrum in the specification refers to a height of a peak of the XANES spectrum from a pre-edge line. Further, an “intensity of a continuous band structure” in the specification refers to a difference between a straight line (post-edge line) fitted to a structure in which an absorbance intensity is continuous such as the first continuous band structure st2 and the above pre-edge line, at a position of +150 eV from a position of an absorption edge. A position of an absorption edge in an absorption edge structure refers to a position of an inflection point present on the lowest energy side of the absorption edge structure in which the XANES spectrum sharply rises. In other words, the position of the absorption edge is a position of a maximum point on the lowest energy side of the absorption edge structure among maximum points of a first derivative of the XANES spectrum.

The pre-edge line in the XANES spectrum is a straight line passing through a data point at −150 eV and a data point at −30 eV in relative value from a position of an absorption edge at each peak. The post-edge line in the XANES spectrum is a straight line obtained when fitting processing is performed in a range of +150 eV to +450 eV in relative value from the position of the absorption edge at each peak.

The “peak” in the specification includes, in addition to a clearly upwardly convex shape having a vertex, a shape which is not upwardly convex, such as a shoulder structure. When neither of the upwardly convex shape nor the shoulder structure is present, an intensity of a maximum value within a specified range is regarded as an intensity of each peak.

### 1.2.2. Feature (2)

When XAFS measurement is performed on the particle with the analysis depth set to a surface, an obtained Fe—K absorption edge XANES spectrum has, as a feature (2), a second absorption edge structure st3 having a peak B and a second continuous band structure st4 positioned at a higher energy side than the second absorption edge structure st3. The peak B has an energy in a range of 7113±1 eV, and satisfies the following intensity ratio. An intensity of the peak B at an energy of 7113 eV is preferably 0.10 or more and 0.38 or less, and more preferably 0.20 or more and 0.35 or less, when an intensity of the second continuous band structure st4 is 1.

It is considered that satisfying such a feature (2) indicates that, due to an influence of Cr which is easily oxidized, an oxide is precipitated on a particle surface and an interatomic distance is changed, and as a result, transition of Fe from a is orbit to a dp hybrid orbit is reduced as compared with the bulk. That is, it is considered that the peak B also corresponds to transition from the is orbit to the dp hybrid orbit by the electrons of Fe absorbing the X-ray energy. It is considered that when this transition is superior in the bulk, this transition is relatively inferior in the surface. Therefore, satisfying the feature (2) indicates that the degree of amorphization of the particle is high.

Therefore, it is considered that the feature (2) reflects a state where atoms are sufficiently randomly arranged even when the content rate of Fe is increased, for example. Accordingly, an amorphous alloy soft magnetic powder satisfying the feature (2) has a high degree of amorphization even when the content rate of Fe is high, and can achieve both a high magnetic permeability and a low coercive force.

When the intensity of the peak B goes below the above lower limit value, the randomness of the atomic arrangement decreases and the magnetization reversal hardly occurs, so that the coercive force may increase. On the other hand, although the intensity of the peak B may exceed the above upper limit value, since a degree of manufacturing difficulty increases, a degree of difficulty in stabilizing quality may increase.

The above Fe—K absorption edge XANES spectrum is a spectrum obtained by setting the analysis depth for the particle to a surface.

### 1.2.3. Feature (3)

When XAFS measurement is performed on the particle with the analysis depth set to a bulk, a radial distribution function obtained by Fourier transform of an obtained Fe—K absorption edge EXAFS spectrum preferably has a peak C and a peak D as a feature (3).

The peak C is a peak having an interatomic distance in a range of 0.10 nm or more and 0.14 nm or less. The peak D is a peak having an interatomic distance in a range of 0.18 nm or more and 0.22 nm or less. When an intensity of the peak C is C and an intensity of the peak D is D, an intensity ratio C/D is preferably 0.7 or more, more preferably 0.9 or more and 2.5 or less, and still more preferably 1.1 or more and 2.0 or less.

The peak C is a structure belonging to an O atom (first adjacent O atom) adjacent to an Fe atom which is an absorption atom. The peak D is a structure belonging to an Fe atom (first adjacent Fe atom) adjacent to the Fe atom which is the absorption atom, or a structure belonging to an Si atom (first adjacent Si atom) adjacent to the Fe atom which is the absorption atom.

The intensity ratio C/D being within the above range indicates that, due to an influence of Cr which is easily oxidized, Fe—O atom pairs derived from Fe oxides are relatively more than Fe—Si atom pairs or Fe—Fe atom pairs. This is considered to support that the number of atoms deviated from atomic arrangement in a crystalline state is relatively large. Therefore, a particle satisfying the feature (3) has a high degree of amorphization even when the content rate of Fe is high, and can achieve both a high magnetic permeability and a low coercive force. Since the radial distribution function having the feature (3) is obtained by setting the analysis depth to a bulk, it is considered to support that the entire particle has a high degree of amorphization.

### 1.2.4. Feature (4)

When XAFS measurement is performed on particles with the analysis depth set to a surface, a radial distribution function obtained by Fourier transform of an obtained Fe—K absorption edge EXAFS spectrum preferably has a peak E and a peak F as a feature (4).

The peak E is a peak having an interatomic distance in a range of 0.10 nm or more and 0.14 nm or less. The peak F is a peak having an interatomic distance in a range of 0.18 nm or more and 0.22 nm or less. When an intensity of the peak E is E and an intensity of the peak F is F, an intensity ratio E/F is preferably 0.20 or more to 0.70 or less, and more preferably 0.30 or more to 0.50 or less.

The peak E is a structure belonging to an O atom (first adjacent O atom) adjacent to the Fe atom which is the absorption atom. The peak F is a structure belonging to an Fe atom (first adjacent Fe atom) adjacent to the Fe atom which is the absorption atom, or a structure belonging to an Si atom (first adjacent Si atom) adjacent to the Fe atom which is the absorption atom.

The intensity ratio E/F being within the above range indicates that, due to an influence of Cr which is easily oxidized, Fe—O atom pairs derived from Fe oxides are relatively more than Fe—Si atom pairs or Fe—Fe atom pairs. This is considered to support that the number of atoms deviated from the atomic arrangement in a crystalline state is relatively large. Therefore, a particle satisfying the feature (4) has a high degree of amorphization even when the content rate of Fe is high, and can achieve both a high magnetic permeability and a low coercive force.

### 1.3. XAFS Measurement Method

The XAFS measurement can be performed under the following conditions.
Measurement facility: Aichi Synchrotron Radiation Center
Acceleration energy: 1.2 GeV
Accumulated current value: 300 mA
Monochromatization conditions: white X-rays from a bending magnet are monochromatized by a double-crystal spectrometer and used for measurement.
Used beamline (BL) and measurement area: BL5S1
Incident angle to sample: 15° (the incident angle is an incident angle of X-rays with respect to a normal line of a sample surface.)
Energy calibration: before performing XAFS measurement, transmission measurement is performed on an Fe foil (reference sample), and an energy axis is calibrated.
Measurement method: simultaneous measurement of a conversion electron yield (CEY) and a partial fluorescence yield (PFY)
Preparation for measurement: introduction into a He atmospheric pressure chamber and He gas replacement for about 30 minutes before measurement
I₀ measurement method: Au-mesh
Data processing for obtaining radial distribution function:

XAFS spectrum data is acquired by a QuickXAFS method. A background noise is subtracted from the obtained XAFS spectrum data by a standard procedure. An energy E₀ (x axis) of a K absorption edge in each spectrum is an energy value (x axis) at which a first-order differential coefficient becomes maximum in a spectrum near a K absorption edge in an X-ray absorption spectrum. Subsequently, with the absorption edge energy E₀ as an origin, a baseline with an intensity axis of zero is set such that an average intensity in a range of, for example, −150 eV to −30 eV is zero. A baseline with an intensity axis of 1 is also set such that an average intensity in a range of +150 eV to +450 eV is 1. Subsequently, a waveform is adjusted using the two baselines.

Next, based on the X-ray absorption spectrum prepared as described above, an EXAFS spectrum of a K absorption edge of Fe is obtained and a radial distribution function is obtained as follows. First, EXAFS vibration analysis is performed on adjusted X-ray absorption spectrum data using EXAFS analysis software Athena. For each spectrum, an absorbance (μ₀) of an isolated atom is estimated and an EXAFS function χ(k) is extracted by a spline smoothing method. Finally, an EXAFS function k³χ(k) weighted by k³ is Fourier-transformed, for example, in a range of k from 3.0 Å⁻¹ to 12.0 Å⁻¹. Accordingly, the radial distribution function is obtained.

### 1.4. Other Properties

The degree of amorphization in the amorphous alloy soft magnetic powder can be specified based on a degree of crystallization. The degree of crystallization in the amorphous alloy soft magnetic powder is calculated based on a spectrum obtained by X-ray diffraction for the amorphous alloy soft magnetic powder based on the following formula.

Degree of crystallization={crystal-derived intensity/(crystal-derived intensity+amorphous-derived intensity)}×100

As an X-ray diffractometer, for example, RINT2500V/PC manufactured by Rigaku Corporation is used.

The degree of crystallization measured by such a method is preferably 70% or less, and more preferably 60% or less. Accordingly, improvement in the soft magnetism accompanying amorphization is more remarkable. As a result, the amorphous alloy soft magnetic powder having a sufficiently low coercive force is obtained. In other words, it is preferable that the amorphous alloy soft magnetic powder is entirely amorphous, but may contain a crystal structure at a volume proportion of, for example, 70% or less.

An average particle size D50 of the amorphous alloy soft magnetic powder is not particularly limited, and is preferably 3.0 μm or more and 60.0 μm or less, and more preferably 5.0 μm or more and 50.0 μm or less. Such an amorphous alloy soft magnetic powder has a relatively small average particle size, thereby contributing to implementation of a magnetic element having a small eddy current loss.

In particular, when the average particle size D50 is 20.0 μm or more and 40.0 μm or less, an amorphous alloy soft magnetic powder suitable for use in mixing with another soft magnetic powder having an average particle size smaller than the average particle size D50 is obtained. That is, when the amorphous alloy soft magnetic powder having the average particle size D50 in this range is mixed with another soft magnetic powder having a smaller diameter and subjected to compact molding, the amorphous alloy soft magnetic powder contributes to a higher density of a dust core compared with a case where each of them is independently subjected to compact molding. In addition, the amorphous alloy soft magnetic powder having the average particle size D50 within the above range has a high degree of amorphization even with a large diameter, and thus contributes to implementation of a magnetic element having a high magnetic permeability and a low coercive force.

On the other hand, when the average particle size D50 is 5.0 μm or more and 10.0 μm or less, the amorphous alloy soft magnetic powder contributes to the implementation of a magnetic element having a particularly small eddy current loss.

The average particle size D50 of the amorphous alloy soft magnetic powder is obtained as a particle size whose accumulation is 50% from a small diameter side in a volume-based particle size distribution obtained by a laser diffraction method.

When the average particle size of the amorphous alloy soft magnetic powder goes below the above lower limit value, the particle size is too small, and thus the filling properties during compact molding may not be sufficiently enhanced. On the other hand, when the average particle size of the amorphous alloy soft magnetic powder exceeds the above upper limit value, the degree of amorphization may not be sufficiently increased because the particle size becomes too large.

Further, with respect to the amorphous alloy soft magnetic powder, in the volume-based particle size distribution obtained by the laser diffraction method, when a particle size whose accumulation is 10% from the small diameter side is defined as D10, and a particle size whose accumulation is 90% from the small diameter side is defined as D90, (D90−D10)/D50 is preferably about 1.3 or more and 3.0 or less, and more preferably about 1.5 or more and 2.5 or less. (D90−D10)/D50 is an index indicating a degree of expansion of the particle size distribution, and when the index is within the above range, the filling properties of the amorphous alloy soft magnetic powder are particularly good. Accordingly, the amorphous alloy soft magnetic powder which can be used to manufacture a magnetic element having a particularly high magnetic permeability is obtained.

The coercive force of the amorphous alloy soft magnetic powder according to the embodiment is preferably 24 A/m or more (0.3 Oe or more) and 199 A/m or less (2.5 Oe or less), more preferably 40 A/m or more (0.5 Oe or more) and 175 A/m or less (2.2 Oe or less), and still more preferably 56 A/m or more (0.7 Oe or more) and 159 A/m or less (2.0 Oe or less).

By using the amorphous alloy soft magnetic powder having such a low coercive force, it is possible to manufacture a magnetic element capable of sufficiently reducing a hysteresis loss.

When the coercive force goes below the above lower limit value, it is difficult to stably manufacture an amorphous alloy soft magnetic powder having such a low coercive force, and excessive pursuit of the coercive force may affect the magnetic permeability. On the other hand, when the coercive force exceeds the above upper limit value, the hysteresis loss is increased, and thus an iron loss of the dust core may be increased.

The coercive force of the amorphous alloy soft magnetic powder can be measured, for example, by a vibrating sample magnetometer such as TM-VSM1230-MHHL manufactured by TAMAKAWA CO., LTD.

The saturation magnetic flux density of the amorphous alloy soft magnetic powder according to the embodiment is preferably 1.60 T or more and 2.20 T or less, more preferably 1.60 T or more and 2.10 T or less, and still more preferably 1.65 T or more and 2.00 T or less.

By using the amorphous alloy soft magnetic powder having a relatively high saturation magnetic flux density, the size of the magnetic element can be reduced and the output of the magnetic element can be increased.

When the saturation magnetic flux density goes below the above lower limit value, it may be difficult to reduce the size of the magnetic element and increase the output of the magnetic element. On the other hand, when the saturation magnetic flux density exceeds the above upper limit value, it is difficult to stably manufacture the amorphous alloy soft magnetic powder having such a saturation magnetic flux density, and when the saturation magnetic flux density is excessively pursued, the coercive force may be affected and increased.

The saturation magnetic flux density of the amorphous alloy soft magnetic powder is measured by the following method.

First, a true density p of a soft magnetic powder is measured by a full-automatic gas displacement densitometer AccuPyc 1330 manufactured by Micromeritics Instrument Corporation. Next, a maximum magnetization Mm of the soft magnetic powder is measured by a vibrating sample magnetometer, VSM system, TM-VSM1230-MHHL manufactured by TAMAKAWA CO., LTD. A saturation magnetic flux density Bs is calculated according to the following formula.

Bs=4π/10000×ρ×Mm

The magnetic permeability of the amorphous alloy soft magnetic powder according to the embodiment at a measurement frequency of 100 kHz is preferably 20.0 or more, and more preferably 21.0 or more. Such an amorphous alloy soft magnetic powder hardly saturates the magnetic flux density even when a high magnetic field is applied, thereby contributing to implementation of a dust core having a high saturation magnetic flux density or a small dust core. An upper limit value of the magnetic permeability is not particularly limited, and is 50.0 in consideration of stable manufacturing.

The magnetic permeability of the amorphous alloy soft magnetic powder can be measured, for example, as a relative permeability, that is, an effective permeability, obtained based on a self-inductance of a closed magnetic circuit magnetic core coil manufactured by preparing a dust core having a toroidal shape. For the measurement of the magnetic permeability, for example, an impedance analyzer such as 4194A manufactured by Agilent Technologies, Inc. is used, and a measurement frequency is set to 1 MHz. A winding number of an exciting coil is 7, and a wire diameter of a winding is 0.6 mm.

In the amorphous alloy soft magnetic powder according to the embodiment, an apparent density and a tap density are preferably within predetermined ranges. Specifically, when the apparent density g/cm³ of the amorphous alloy soft magnetic powder is 100, the tap density g/cm³ is preferably 103 or more and 120 or less, more preferably 105 or more and 115 or less, and still more preferably 107 or more and 113 or less. It can be said that such an amorphous alloy soft magnetic powder is relatively difficult to be filled when not tapped (excited), and is easily filled when tapped. Based on this fact, when the tap density is within the above range, it can be said that the amorphous alloy soft magnetic powder is a powder having a particle size distribution in which the number of irregularly shaped particles is relatively small and filling properties are high. Such an amorphous alloy soft magnetic powder can be used to manufacture a dust core having a high density. Therefore, a saturation magnetic flux density and a magnetic permeability of the magnetic element can be particularly increased.

The apparent density of the amorphous alloy soft magnetic powder is preferably 4.55 g/cm³ or more and 4.80 g/cm³ or less, and more preferably 4.58 g/cm³ or more and 4.70 g/cm³ or less.

The tap density of the amorphous alloy soft magnetic powder is preferably 4.95 g/cm³ or more and 5.30 g/cm³ or less, and more preferably 5.00 g/cm³ or more and 5.20 g/cm³ or less.

When the apparent density and the tap density of the amorphous alloy soft magnetic powder are within the above ranges, the saturation magnetic flux density and the magnetic permeability of the magnetic element can be particularly increased.

When a relative value of the tap density goes below the above lower limit value, the filling properties of the amorphous alloy soft magnetic powder may decrease when the amorphous alloy soft magnetic powder is compacted to obtain a dust core. On the other hand, when the relative value of the tap density exceeds the above upper limit value, a shrinkage percentage may increase when the amorphous alloy soft magnetic powder is compacted to obtain a dust core. Therefore, the dust core is likely to be deformed, and dimensional accuracy may be decreased.

The apparent density of the amorphous alloy soft magnetic powder is measured in accordance with metallic powders-apparent density determination method specified in JIS Z 2504:2012.

The tap density of the amorphous alloy soft magnetic powder is measured in accordance with metallic powders-tap density determination method specified in JIS Z 2512:2012.

### 1.5. Effects of Embodiment

As described above, the amorphous alloy soft magnetic powder according to the embodiment contains particles having a composition with the compositional formula (Fe₁₋ₓCrₓ)ₐ(Si_{1-y}B_{y})_{100-a-b}C_{b} expressed by an atomic ratio (where 0<x≤0.06, 0.3≤y≤0.7, 70.0≤a≤81.0, and 0<b≤3.0).

When the XAFS measurement is performed on such a particle with the analysis depth set to a bulk, the obtained Fe—K absorption edge XANES spectrum has the first absorption edge structure st1 having the peak A having the energy within the range of 7113±1 eV and the first continuous band structure st2 positioned at a higher energy side than the first absorption edge structure st1. The intensity of the peak A at the energy of 7113 eV is 0.60 or more and 0.90 or less when the intensity of the first continuous band structure st2 is 1.

A particle having such a configuration has a high degree of amorphization. Therefore, an amorphous alloy soft magnetic powder having a low coercive force can be implemented even with a high magnetic permeability due to a high concentration of Fe. That is, an amorphous alloy soft magnetic powder achieving both a high magnetic permeability and a low coercive force is obtained.

The XANES spectrum having the first absorption edge structure st1 and the first continuous band structure st2 as described above is a spectrum obtained by setting the analysis depth to a bulk. Therefore, the spectrum satisfying the above feature supports that the particle has a high degree of amorphization in the entire particle.

In the amorphous alloy soft magnetic powder according to the embodiment, when the XAFS measurement is performed on such a particle with the analysis depth set to a surface, the obtained Fe—K absorption edge XANES spectrum has the second absorption edge structure st3 having the peak B having the energy within the range of 7113±1 eV and the second continuous band structure st4 positioned at a higher energy side than the second absorption edge structure st3. The intensity of the peak B at the energy of 7113 eV is preferably 0.10 or more and 0.38 or less when the intensity of the second continuous band structure st4 is 1.

A particle having such a configuration has a high degree of amorphization. Therefore, an amorphous alloy soft magnetic powder having a low coercive force can be implemented even with a high magnetic permeability due to a high concentration of Fe. That is, an amorphous alloy soft magnetic powder achieving both a high magnetic permeability and a low coercive force is obtained.

In the amorphous alloy soft magnetic powder according to the embodiment, the radial distribution function, which is obtained by performing the XAFS measurement on a particle with the analysis depth set to a bulk to obtain an Fe—K absorption edge EXAFS spectrum and then performing the Fourier transform on the Fe—K absorption edge EXAFS spectrum, has the peak C and the peak D. The peak C is a peak having an interatomic distance in a range of 0.10 nm or more and 0.14 nm or less. The peak D is a peak having an interatomic distance in a range of 0.18 nm or more and 0.22 nm or less. When the intensity of the peak C is C and the intensity of the peak D is D, the intensity ratio C/D is preferably 0.7 or more.

A particle having such a configuration has a high degree of amorphization even when the content rate of Fe is high, and can achieve both a high magnetic permeability and a low coercive force.

The radial distribution function having the above feature is a curve obtained by setting the analysis depth to a bulk. Therefore, the curve satisfying the above feature supports that the particle has a high degree of amorphization in the entire particle.

In the amorphous alloy soft magnetic powder according to the embodiment, the radial distribution function, which is obtained by performing the XAFS measurement on a particle with the analysis depth set to a surface to obtain an Fe—K absorption edge EXAFS spectrum and then performing the Fourier transform on the Fe—K absorption edge EXAFS spectrum, has the peak E and the peak F. The peak E is a peak having an interatomic distance in a range of 0.10 nm or more and 0.14 nm or less. The peak F is a peak having an interatomic distance in a range of 0.18 nm or more and 0.22 nm or less. When the intensity of the peak E is E and the intensity of the peak F is F, the intensity ratio E/F is preferably 0.20 or more and 0.70 or less.

A particle having such a configuration has a high degree of amorphization even when the content rate of Fe is high, and can achieve both a high magnetic permeability and a low coercive force.

The amorphous alloy soft magnetic powder according to the embodiment preferably has a magnetic permeability of 20.0 or more at a measurement frequency of 100 kHz and a coercive force of 24 A/m or more (0.3 Oe or more) and 199 A/m or less (2.5 Oe or less).

Such an amorphous alloy soft magnetic powder can achieve both a high magnetic permeability and a low coercive force at a particularly high level.

### 2. Method for Manufacturing Amorphous Alloy Soft Magnetic Powder

Next, a method for manufacturing an amorphous alloy soft magnetic powder according to the embodiment will be described.

The amorphous alloy soft magnetic powder according to the embodiment may be manufactured by any manufacturing method, and is manufactured by, for example, an atomization method such as a water atomization method, a gas atomization method, or a rotary water atomization method, or various powdering methods such as a reduction method, a carbonyl method, or a pulverization method.

Examples of the atomization method include, depending on a type of a cooling medium or a device configuration, a water atomization method, a gas atomization method, and a rotary water atomization method. Among these methods, the amorphous alloy soft magnetic powder is preferably manufactured by an atomization method, more preferably manufactured by a water atomization method or a rotary water atomization method, and still more preferably manufactured by a rotary water atomization method. The atomization method is a method for manufacturing a powder by causing a molten raw material to collide with a fluid such as a liquid or a gas injected at a high speed so as to pulverize and cool the molten raw metal.

The “water atomization method” in the specification refers to a method in which a liquid such as water or oil is used as a coolant, and in a state where the liquid is injected in an inverted conical shape which converges on one point, the molten metal is caused to flow downward toward a convergence point and to collide with the convergence point, so that a metal powder is manufactured.

According to the rotary water atomization method, since the molten metal can be cooled at an extremely high speed, amorphization is particularly easily achieved.

When the amorphous alloy soft magnetic powder is to be manufactured, a cooling rate of the molten metal preferably exceeds 10⁶ K/sec, and is more preferably 10⁷ K/sec or more. Accordingly, a sufficiently amorphized amorphous alloy soft magnetic powder is obtained. That is, even with a relatively high content rate of Fe in the composition, the amorphous alloy soft magnetic powder is obtained in which amorphization can be achieved and a spectrum having the above feature, as obtained by the XAFS measurement, can be obtained. In particular, according to the rotary water atomization method, the cooling rate exceeding 10⁶ K/sec can be easily achieved.

Hereinafter, a method for manufacturing the amorphous alloy soft magnetic powder by the rotary water atomization method will be further described.

In the rotary water atomization method, a coolant is injected and supplied along an inner circumferential surface of a cooling tubular body and swirled along the inner circumferential surface of the cooling tubular body to form a coolant layer at the inner circumferential surface. On the other hand, a raw material for the amorphous alloy soft magnetic powder is melted, and a liquid or gas jet is sprayed to the obtained molten metal while the molten metal naturally drops. When the molten metal is scattered in this way, the scattered molten metal is taken into the coolant layer. As a result, the scattered and pulverized molten metal is rapidly cooled and solidified, and an amorphous alloy soft magnetic powder is obtained.

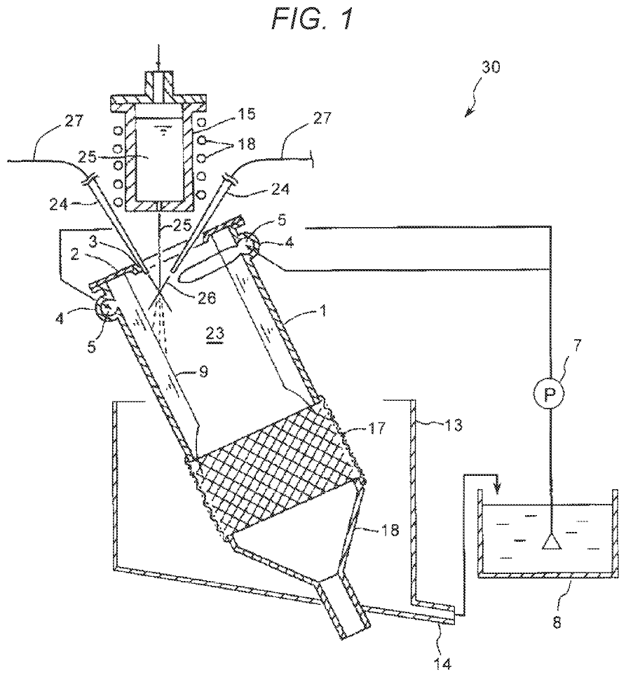

FIG. 1 is a longitudinal sectional view showing an example of a device for manufacturing an amorphous alloy soft magnetic powder by a rotary water atomization method.

A powder manufacturing device 30 shown in FIG. 1 includes a cooling tubular body 1, a crucible 15, a pump 7, and a jet nozzle 24. The cooling tubular body 1 is a tubular body for forming a coolant layer 9 at an inner circumferential surface of the cooling tubular body 1. The crucible 15 is a supply container for a molten metal 25 to flow down and to be supplied to a space portion 23 inside the coolant layer 9. The pump 7 supplies a coolant to the cooling tubular body 1. The jet nozzle 24 is used to inject a gas jet 26 for dividing the flowing down molten metal 25 in the form of minute flow into liquid droplets. The molten metal 25 is prepared according to a composition of the amorphous alloy soft magnetic powder.

The cooling tubular body 1 has a cylindrical shape, and is provided such that a tubular body axis line extends along a vertical direction or is inclined at an angle of 30° or less with respect to the vertical direction.

An upper end opening of the cooling tubular body 1 is closed by a lid body 2. An opening portion 3 for supplying the molten metal 25 flowing down to the space portion 23 of the cooling tubular body 1 is formed in the lid body 2.

A coolant injecting pipe 4 for injecting the coolant to the inner circumferential surface of the cooling tubular body 1 is provided in an upper portion of the cooling tubular body 1. A plurality of discharge ports 5 of the coolant injecting pipe 4 are provided at equal intervals along a circumferential direction of the cooling tubular body 1.

The coolant injecting pipe 4 is coupled to a tank 8 via pipes to which the pump 7 is coupled, and a coolant in the tank 8 sucked up by the pump 7 is injected and supplied via the coolant injecting pipe 4 into the cooling tubular body 1. Accordingly, the coolant gradually flows down while rotating along the inner circumferential surface of the cooling tubular body 1, and accordingly, the coolant layer 9 along the inner circumferential surface is formed. A cooler may be interposed as necessary in the tank 8 or in a middle of a circulation flow path. As the coolant, in addition to water, oil such as silicone oil is used, and various additives may be further added. By removing dissolved oxygen in the coolant in advance, oxidation of a manufactured powder can be reduced.

A cylindrical liquid draining mesh body 17 is continuously provided at a lower portion of the cooling tubular body 1. A funnel-shaped powder recovery container 18 is provided below the liquid draining mesh body 17. A coolant recovery cover 13 is provided around the liquid draining mesh body 17 so as to cover the liquid draining mesh body 17. A drain port 14 formed in a bottom portion of the coolant recovery cover 13 is coupled via a pipe to the tank 8.

The jet nozzle 24 is provided in the space portion 23. The jet nozzle 24 is attached to a tip end of a gas supply pipe 27 inserted through the opening portion 3 of the lid body 2, and an injection port of the jet nozzle 24 is directed to the molten metal 25 in the form of minute flow.

In order to manufacture the amorphous alloy soft magnetic powder in such a powder manufacturing device 30, first, the pump 7 is operated to form the coolant layer 9 at the inner circumferential surface of the cooling tubular body 1. Next, the molten metal 25 in the crucible 15 is caused to flow down into the space portion 23. When the gas jet 26 is sprayed to the flowing-down molten metal 25, the molten metal 25 is scattered, and the pulverized molten metal 25 is caught in the coolant layer 9. As a result, the pulverized molten metal 25 is cooled and solidified, and an amorphous alloy soft magnetic powder is obtained.

In the rotary water atomization method, since an extremely high cooling rate can be stably maintained by continuously supplying the coolant, amorphization of the manufactured amorphous alloy soft magnetic powder is promoted.

Since the molten metal 25 miniaturized to a certain size by the gas jet 26 falls by inertia until the molten metal 25 is caught in the coolant layer 9, liquid droplets are made spherical at that time. As a result, an amorphous alloy soft magnetic powder having a good particle size distribution and excellent filling properties can be manufactured.

For example, a downflow amount of the molten metal 25 flowing down from the crucible 15 varies depending on a device size and the like, and preferably exceeds 1.0 kg/min and 20.0 kg/min or less, and is more preferably 2.0 kg/min or more and 10.0 kg/min or less. Accordingly, since an amount of the molten metal 25 flowing down for a certain period of time can be optimized, it is possible to efficiently manufacture an amorphous alloy soft magnetic powder in which sufficient amorphization is achieved and a spectrum having the above feature, as obtained by the XAFS measurement, can be obtained. The cooling rate of the molten metal 25 per unit amount can be increased. A degree of amorphization can be increased.

A pressure of the gas jet 26 is slightly different depending on a configuration of the jet nozzle 24, and is preferably 2.0 MPa or more and 20.0 MPa or less, and more preferably 3.0 MPa or more and 10.0 MPa or less. Accordingly, by optimizing a particle size when the molten metal 25 is scattered, it is possible to manufacture an amorphous alloy soft magnetic powder in which sufficient amorphization is achieved and a spectrum having the above feature, as obtained by the XAFS measurement, can be obtained. That is, when the pressure of the gas jet 26 goes below the above lower limit value, it is difficult to sufficiently and finely scatter the molten metal 25, and the particle size is likely to increase. As a result, the cooling rate of inside of the liquid droplets decreases, and amorphization may be insufficient. On the other hand, when the pressure of the gas jet 26 exceeds the above upper limit value, the particle size of the liquid droplets after the scattering may be too small. As a result, the liquid droplets are slowly cooled by the gas jet 26, and rapid cooling by the coolant layer 9 may not be performed, which may result in insufficient amorphization.

A flow rate of the gas jet 26 is not particularly limited, and is preferably 1.0 Nm³/min or more and 20.0 Nm³/min or less.

A pressure at a time of injecting the coolant supplied to the cooling tubular body 1 is preferably about 5 MPa or more and 200 MPa or less, and more preferably about 10 MPa or more and 100 MPa or less. Accordingly, a flow speed of the coolant layer 9 is optimized, and the pulverized molten metal 25 is less likely to have an irregular shape. As a result, the amorphous alloy soft magnetic powder having more excellent filling properties can be obtained. The cooling rate of the molten metal 25 by the coolant can be sufficiently increased.

As described above, an amorphous alloy soft magnetic powder is obtained.

A particle size of the amorphous alloy soft magnetic powder can be reduced by, for example, performing operations such as reducing the downflow amount of the molten metal 25 flowing down from the crucible 15, increasing the pressure of the gas jet 26, and increasing the flow rate of the gas jet 26. The particle size can be increased by performing opposite operations.

A particle size distribution of the amorphous alloy soft magnetic powder can be narrowed by, for example, setting the downflow amount of the molten metal 25, and the pressure and the flow rate of the gas jet 26 within the above ranges. With this setting, a ratio of a tap density to an apparent density of the amorphous alloy soft magnetic powder can be increased.

The amorphous alloy soft magnetic powder may be subjected to a classification treatment as necessary. Examples of a method for the classification treatment include dry classification such as sieving classification, inertial classification, centrifugal classification, and wind classification, and wet classification such as sedimentation classification.

An insulating film may be formed at each particle surface of the obtained soft magnetic powder as necessary. A constituent material for the insulating film is not particularly limited. Examples thereof include inorganic materials such as phosphates such as magnesium phosphate, calcium phosphate, zinc phosphate, manganese phosphate, and cadmium phosphate, and silicates such as sodium silicate.

### 3. Dust Core and Magnetic Element

Next, a dust core and a magnetic element according to the embodiment will be described.

The magnetic element according to the embodiment can be applied to various magnetic elements including a magnetic core, such as a choke coil, an inductor, a noise filter, a reactor, a transformer, a motor, an actuator, an electromagnetic valve, and a generator. The dust core according to the embodiment can be applied to a magnetic core in these magnetic elements.

Hereinafter, two types of coil components will be representatively described as an example of the magnetic element.

### 3.1. Toroidal Type

First, a toroidal type coil component, which is a magnetic element according to the embodiment, will be described.

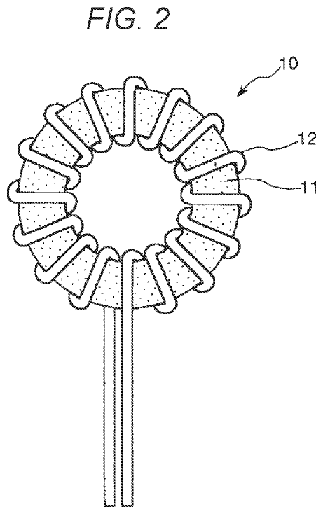

FIG. 2 is a plan view schematically showing the toroidal type coil component. A coil component 10 shown in FIG. 2 includes a ring-shaped dust core 11 and a conductive wire 12 wound around the dust core 11.

The dust core 11 is obtained by mixing the above amorphous alloy soft magnetic powder and a binder, supplying the obtained mixture to a mold, and pressing and molding the mixture. That is, the dust core 11 is a green compact containing the amorphous alloy soft magnetic powder according to the embodiment. Such a dust core 11 has a high magnetic permeability and a low coercive force. Therefore, when the coil component 10 including the dust core 11 is mounted on an electronic device or the like, power consumption of the electronic device can be reduced, a size of the electronic device can be reduced and an output of the electronic device can be increased.

The coil component 10 includes such a dust core 11. Such a coil component 10 contributes to a reduction in size of the electronic device and an increase in the output of the electronic device.

Examples of a constituent material for the binder used for preparing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material for the conductive wire 12 include a material having high conductivity, for example, a metal material containing Cu, Al, Ag, Au, and Ni. An insulating film is provided as necessary at a surface of the conductive wire 12.

A shape of the dust core 11 is not limited to a ring shape shown in FIG. 2, and may be, for example, a shape in which a part of the ring is missing, or a shape in which a shape in a longitudinal direction is linear.

The dust core 11 may contain, as necessary, a soft magnetic powder other than the amorphous alloy soft magnetic powder according to the above embodiment or a non-magnetic powder. In this case, a proportion of the amorphous alloy soft magnetic powder in the mixed powder obtained by mixing the powders preferably exceeds 50 mass %, and is more preferably 60 mass % or more.

### 3.2. Closed Magnetic Circuit Type

Next, a closed magnetic circuit type coil component, which is the magnetic element according to the embodiment, will be described.

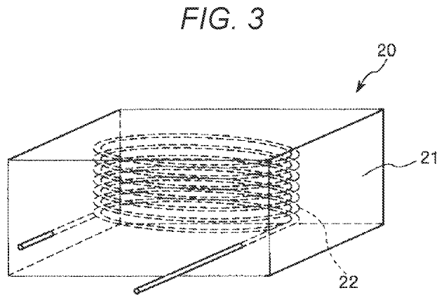

FIG. 3 is a transparent perspective view schematically showing the closed magnetic circuit type coil component.

Hereinafter, the closed magnetic circuit type coil component will be described. In the following description, differences from the toroidal type coil component will be mainly described, and description of similar matters is omitted.

A coil component 20 shown in FIG. 3 includes a chip-shaped dust core 21, and a conductive wire 22 embedded in the dust core 21 and formed into a coil shape. That is, the dust core 21 is a green compact containing the amorphous alloy soft magnetic powder according to the embodiment. Such a dust core 21 has a high magnetic permeability and a low coercive force.

The coil component 20 includes such a dust core 21. Such a coil component 20 contributes to a reduction in size of the electronic device and an increase in the output of the electronic device.

The dust core 21 may contain, as necessary, a soft magnetic powder other than the amorphous alloy soft magnetic powder according to the above embodiment or a non-magnetic powder. In this case, a proportion of the amorphous alloy soft magnetic powder in the mixed powder preferably exceeds 50 mass %, and is more preferably 60 mass % or more.

### 4. Electronic Device

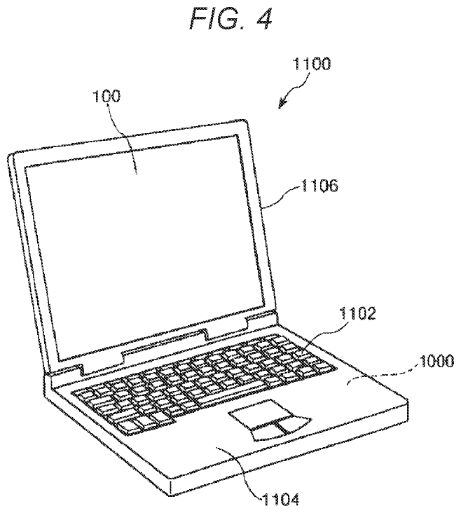

Next, an electronic device including the magnetic element according to the embodiment will be described with reference to FIGS. 4 to 6.

FIG. 4 is a perspective view showing a mobile personal computer which is an electronic device including the magnetic element according to the embodiment. A personal computer 1100 shown in FIG. 4 includes a main body 1104 including a keyboard 1102 and a display unit 1106 including a display 100. The display unit 1106 is rotatably supported by the main body 1104 via a hinge structure. Such a personal computer 1100 is embedded with a magnetic element 1000 such as a choke coil or an inductor for a switching power supply, or a motor.

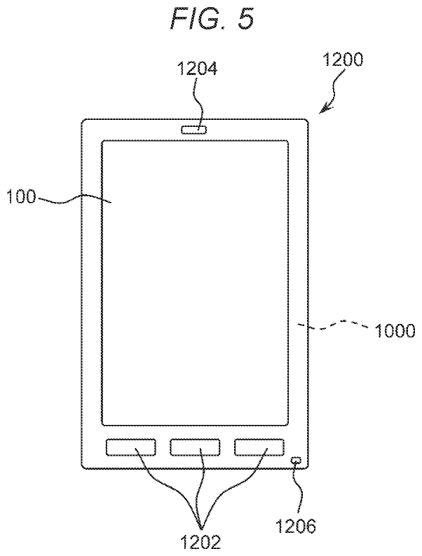

FIG. 5 is a plan view showing a smartphone which is an electronic device including the magnetic element according to the embodiment. A smartphone 1200 shown in FIG. 5 includes a plurality of operation buttons 1202, an earpiece 1204, and a mouthpiece 1206. The display 100 is disposed between the operation buttons 1202 and the earpiece 1204. Such a smartphone 1200 is embedded with the magnetic element 1000 such as an inductor, a noise filter, and a motor.

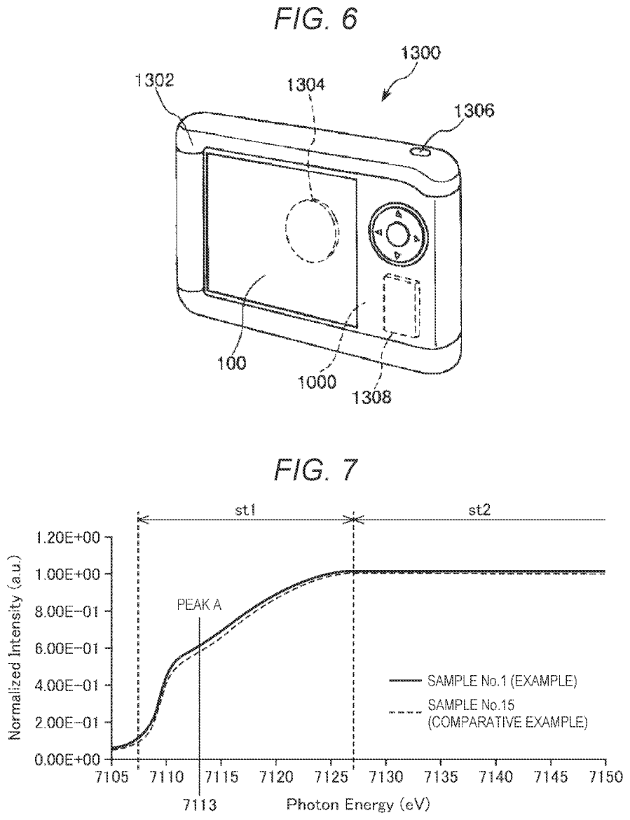

FIG. 6 is a perspective view showing a digital still camera which is an electronic device including the magnetic element according to the embodiment. A digital still camera 1300 photoelectrically converts an optical image of a subject by an imaging element such as a charge coupled device (CCD) to generate an imaging signal.

The digital still camera 1300 shown in FIG. 6 includes the display 100 provided at a rear surface of a case 1302. The display 100 functions as a finder which displays the subject as an electronic image. A light receiving unit 1304 including an optical lens, CCD, or the like is provided at a front surface side of the case 1302, that is, at a rear surface side in the drawing.

When a photographer confirms a subject image displayed on the display 100 and presses a shutter button 1306, an imaging signal of CCD at this time is transferred to and stored in a memory 1308. Such a digital still camera 1300 is also embedded with the magnetic element 1000 such as an inductor and a noise filter.

Examples of the electronic device according to the embodiment include, in addition to the personal computer in FIG. 4, the smartphone in FIG. 5, and the digital still camera in FIG. 6, a mobile phone, a tablet terminal, a watch, ink jet discharge devices such as an ink jet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

As described above, such an electronic device includes the magnetic element according to the embodiment. Accordingly, effects of the magnetic element having a high magnetic permeability and a low coercive force can be obtained, and the size of the electronic device can be reduced and the output of the electronic device can be increased.

As described above, the amorphous alloy soft magnetic powder, the dust core, the magnetic element, and the electronic device according to the present disclosure are described based on the preferred embodiment, but the present disclosure is not limited thereto. For example, in the dust core and the magnetic element according to the present disclosure, each part of the above embodiment may be replaced with any configuration having a similar function, or any configuration may be added to the above embodiment.

In the above embodiment, although the dust core is described as an application example of the amorphous alloy soft magnetic powder according to the present disclosure, the application example is not limited thereto, and, for example, may be a magnetic fluid, a magnetic shielding sheet, or a magnetic device such as a magnetic head. Shapes of the dust core and the magnetic element are not limited to those shown in the drawings, and may be any shape.

### EXAMPLES

Next, specific Examples of the present disclosure will be described.

### 5. Manufacturing of Dust Core

### 5.1. Sample No. 1

First, a raw material was melted in a high-frequency induction furnace and pulverized by a rotary water atomization method to obtain an amorphous alloy soft magnetic powder. At this time, a downflow amount of a molten metal flowing down from a crucible was 10.0 kg/min, a pressure of a gas jet was 10.0 MPa, a flow rate of the gas jet was 10.0 Nm³/min, and a pressure of a coolant was 40 MPa. A cooling rate by the rotary water atomization method was 10⁷ K/sec.

Next, classification was performed by a classifier using a mesh having an opening of 150 μm. An alloy composition of the classified amorphous alloy soft magnetic powder is shown in Table 1. For specifying the alloy composition, a solid emission spectrometer, model: SPECTROLAB, type: LAVMB08A manufactured by SPECTRO, was used.

Next, the obtained amorphous alloy soft magnetic powder was mixed with an epoxy resin as a binder and toluene as an organic solvent, and a mixture was obtained. An addition amount of the epoxy resin was 2 parts by mass with respect to 100 parts by mass of the amorphous alloy soft magnetic powder.

Next, the obtained mixture was stirred and then dried for a short time, and a massive dried body was obtained. Next, the dried body was sieved with a sieve having an opening of 400 μm, and the dried body was pulverized, and a granulated powder was obtained. The obtained granulated powder was dried at 50° C. for 1 hour.

Next, a mold is filled with the obtained granulated powder, and a molded product was obtained based on the following molding conditions.

Molding Conditions
Molding method: press molding
Shape of molded product: ring shape
Dimensions of molded product: outer diameter 14 mm, inner diameter 8 mm, thickness 3 mm
Molding pressure: 3 t/cm² (294 MPa)

Next, the molded product was heated in an air atmosphere at a temperature of 150° C. for 0.50 hour to cure the binder. Accordingly, a dust core was obtained.

### 5.2. Sample Nos. 2 to 11

Dust cores were obtained in the same manner as in Sample No. 1 except that amorphous alloy soft magnetic powders shown in Table 1 were used. At this time, by adjusting a downflow amount of a molten metal in a range of 2.0 kg/min or more and 10.0 kg/min or less, and adjusting a pressure of a gas jet in a range of 3.0 MPa or more and 10.0 MPa or less, powders with a result of XAFS measurement shown in Table 1 were manufactured.

### 5.3. Sample Nos. 12 to 14

Amorphous alloy soft magnetic powders having compositions shown in Table 1 were manufactured and dust cores were obtained in the same manner as in Sample No. 1 except that a water atomization method was used instead of the rotary water atomization method. A cooling rate by the water atomization method was 10⁶ K/sec. By adjusting a downflow amount of a molten metal in the range of 2.0 kg/min or more and 10.0 kg/min or less, powders with a result of XAFS measurement shown in Table 1 were manufactured.

### 5.4. Sample Nos. 15 to 17

Dust cores were obtained in the same manner as in Sample No. 12 except that amorphous alloy soft magnetic powders shown in Table 1 were used. In Sample Nos. 15 to 17, a cooling rate was less than 10⁶ K/sec by changing conditions set in the water atomization method. B_{y} setting a downflow amount of a molten metal to be more than that in the Sample Nos. 12 to 14, powders with a result of XAFS measurement shown in Table 1 were manufactured.

In Table 1, among the amorphous alloy soft magnetic powders in the Sample Nos., amorphous alloy soft magnetic powders corresponding to the present disclosure are shown as “Examples”, and amorphous alloy soft magnetic powders not corresponding to the present disclosure are shown as “Comparative Examples”.

### 6. Evaluation of Amorphous Alloy Soft Magnetic Powder and Magnetic Element

### 6.1. XAFS Measurement of Amorphous Alloy Soft Magnetic Powder

XAFS measurement was performed on the amorphous alloy soft magnetic powders in Sample No. 1 (Example) and Sample No. 15 (Comparative Example) as representatives of the amorphous alloy soft magnetic powders obtained in Examples and Comparative Examples. Measurement results are shown in FIGS. 7 to 10.

### 6.1.1. Fe—K Absorption Edge XANES Spectrum Obtained by Setting Analysis Depth to Bulk

FIG. 7 shows Fe—K absorption edge XANES spectrums obtained by setting an analysis depth to a bulk for the amorphous alloy soft magnetic powders in Sample No. 1 (Example) and Sample No. 15 (Comparative Example).

As shown in FIG. 7, the peak A has a shoulder structure. For the peak A, when the intensity of the first continuous band structure st2 was set to 1, a relative value of the intensity of the peak A at an energy of 7113 eV, that is, an intensity A was calculated. A calculation result is shown in Table 1.

Similarly, the intensity A was calculated for the amorphous alloy soft magnetic powders in other Examples and Comparative Examples. Calculation results are shown in Table 1. In each XANES spectrum shown in FIG. 7, a position of an Fe—K absorption edge is estimated to be 7109 eV.

### 6.1.2. Fe—K Absorption Edge XANES Spectrum Obtained by Setting Analysis Depth to Surface

FIG. 8 shows Fe—K absorption edge XANES spectrums obtained by setting the analysis depth to a surface for the amorphous alloy soft magnetic powders in Sample No. 1 (Example) and Sample No. 15 (Comparative Example).

As shown in FIG. 8, the peak B has a shoulder structure. For the peak B, when the intensity of the second continuous band structure st4 was set to 1, a relative value of the intensity of the peak B at an energy of 7113 eV was calculated. A calculation result is shown in Table 1.

Similarly, an intensity B was calculated for the amorphous alloy soft magnetic powders in other Examples and Comparative Examples. Calculation results are shown in Table 1.

### 6.1.3. Radial Distribution Function Based on Fe—K Absorption Edge EXAFS Spectrum Obtained by Setting Analysis Depth to Bulk

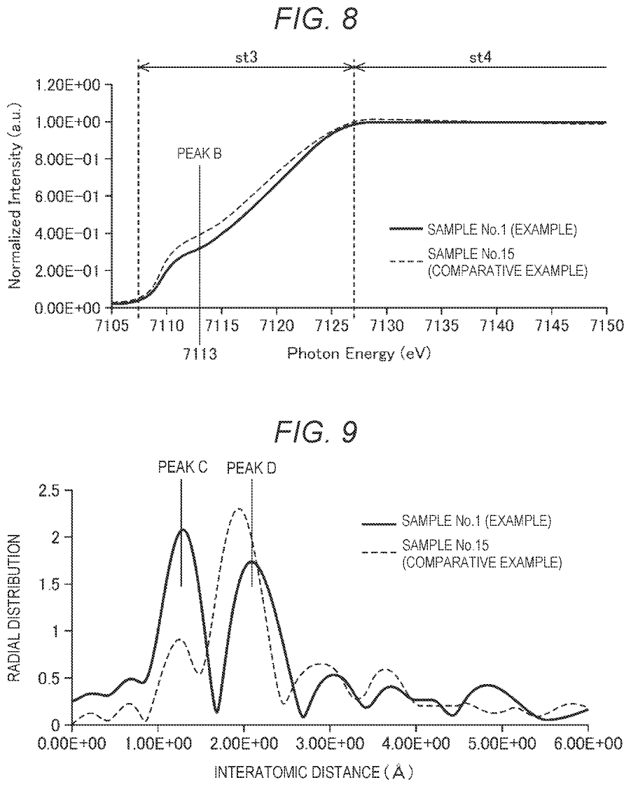

FIG. 9 shows radial distribution functions based on Fe—K absorption edge EXAFS spectrums obtained by setting the analysis depth to a bulk for the amorphous alloy soft magnetic powders in Sample No. 1 (Example) and Sample No. 15 (Comparative Example).

As shown in FIG. 9, the peak C and the peak D were observed in the obtained radial distribution functions. Heights of these peaks were obtained, and the intensity ratio C/D was calculated. A calculation result is shown in Table 1.

Similarly, the intensity ratio C/D was calculated for the amorphous alloy soft magnetic powders in other Examples and Comparative Examples. Calculation results are shown in Table 1. In each XANES spectrum shown in FIG. 8, a position of an Fe—K absorption edge is estimated to be 7109 eV.

### 6.1.4. Radial Distribution Function Based on Fe—K Absorption Edge EXAFS Spectrum Obtained by Setting Analysis Depth to Surface

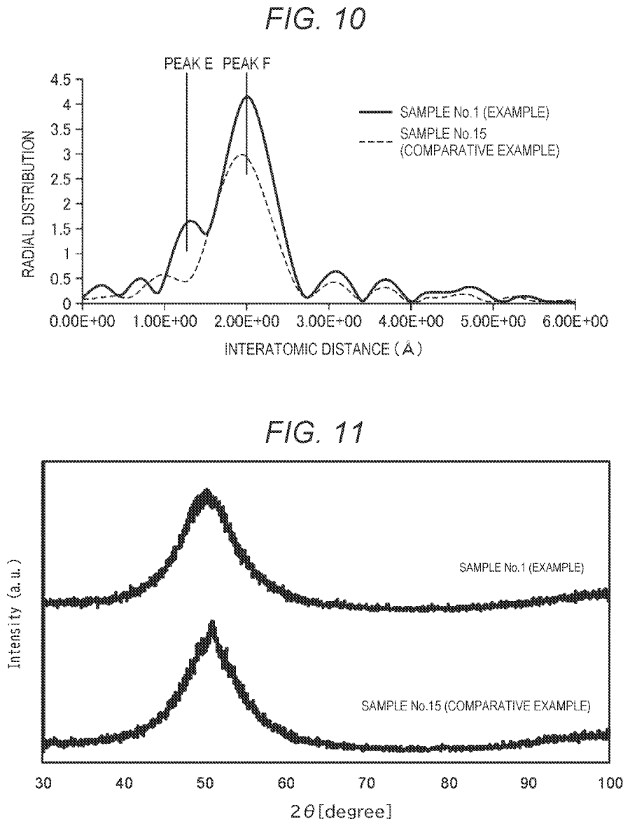

FIG. 10 shows radial distribution functions based on Fe—K absorption edge EXAFS spectrums obtained by setting the analysis depth to a surface for the amorphous alloy soft magnetic powders in Sample No. 1 (Example) and Sample No. 15 (Comparative Example).

As shown in FIG. 10, the peak E and the peak F were observed in the obtained radial distribution functions. Heights of these peaks were obtained, and the intensity ratio E/F was calculated. A calculation result is shown in Table 1.

Similarly, the intensity ratio E/F was calculated for the amorphous alloy soft magnetic powders in other Examples and Comparative Examples. Calculation results are shown in Table 1.

TABLE 1

| | | | | | | | | | | | | | Analysis result for amorphous alloy | | | |
|---|---|---|---|---|---|---|---|---|---|---|---|---|---|---|---|---|
| | | | | | | | | | | | | | soft magnetic powder by XAFS | | | |
| | | | | | | | | | | | | | measurement | | | |
| | | | | | | | | | | | | Method for | | | Radial distribution | |
| | | | | | | | | | | | | manufacturing | | | function | |
| | | Composition of amorphous alloy soft | | | | | | | | | | amorphous | XANES spectrum | | Intensity | |
| | | magnetic powder | | | | | | | | | | alloy soft | Intensity | Intensity | ratio | Intensity |
| | | Fe | Cr | Si | B | C | a | b | x | y | S/P | magnetic | A | B | C/D | ratio E/F |
| Sample No. | | atomic % | | | | | — | | | | — | powder | — | — | — | — |
| No. 1 | Example | 73.8 | 2.3 | 11.1 | 10.9 | 2.0 | 76.0 | 2.0 | 0.0 | 0.5 | 0.4 | Rotary water | 0.65 | 0.33 | 1.2 | 0.4 |
| No. 2 | Example | 73.7 | 2.4 | 10.8 | 11.3 | 2.0 | 76.0 | 2.0 | 0.0 | 0.5 | 0.4 | Rotary water | 0.63 | 0.34 | 1.1 | 0.3 |
| No. 3 | Example | 73.8 | 1.9 | 11.4 | 10.8 | 2.2 | 75.7 | 2.2 | 0.0 | 0.5 | 0.4 | Rotary water | 0.62 | 0.35 | 1.1 | 0.3 |
| No. 4 | Example | 73.9 | 2.3 | 10.9 | 11.1 | 1.9 | 76.2 | 1.9 | 0.0 | 0.5 | 0.4 | Rotary water | 0.68 | 0.33 | 1.3 | 0.5 |
| No. 5 | Example | 73.1 | 1.5 | 11.8 | 11.2 | 2.4 | 74.7 | 2.4 | 0.0 | 0.5 | 0.4 | Rotary water | 0.61 | 0.32 | 1.2 | 0.3 |
| No. 6 | Example | 73.8 | 2.4 | 11.1 | 10.9 | 1.9 | 76.2 | 1.9 | 0.0 | 0.5 | 0.4 | Rotary water | 0.72 | 0.35 | 1.3 | 0.7 |
| No. 7 | Example | 73.9 | 2.3 | 10.7 | 11.3 | 1.8 | 76.2 | 1.8 | 0.0 | 0.5 | 0.2 | Rotary water | 0.75 | 0.37 | 0.9 | 0.2 |
| No. 8 | Example | 74.0 | 2.1 | 10.8 | 11.1 | 2.0 | 76.1 | 2.0 | 0.0 | 0.5 | 0.3 | Rotary water | 0.62 | 0.35 | 0.8 | 0.2 |
| No. 9 | Example | 75.5 | 0.3 | 12.1 | 10.2 | 2.0 | 75.8 | 2.0 | 0.0 | 0.5 | 0.3 | Rotary water | 0.61 | 0.38 | 0.7 | 0.1 |
| No. 10 | Example | 74.5 | 2.2 | 12.3 | 9.0 | 2.0 | 76.8 | 2.0 | 0.0 | 0.4 | 0.6 | Rotary water | 0.60 | 0.37 | 0.8 | 0.2 |
| No. 11 | Example | 75.0 | 2.0 | 8.9 | 12.2 | 2.0 | 77.0 | 2.0 | 0.0 | 0.6 | 0.8 | Rotary water | 0.61 | 0.32 | 0.9 | 0.3 |
| No. 12 | Example | 74.1 | 2.0 | 11.1 | 10.8 | 2.0 | 76.1 | 2.0 | 0.0 | 0.5 | 0.4 | Water | 0.63 | 0.35 | 1.2 | 0.4 |
| | | | | | | | | | | | | atomization | | | | |
| No. 13 | Example | 73.5 | 2.5 | 11.2 | 10.6 | 2.2 | 76.0 | 2.2 | 0.0 | 0.5 | 0.6 | Water | 0.62 | 0.36 | 1.1 | 0.4 |
| | | | | | | | | | | | | atomization | | | | |
| No. 14 | Example | 74.1 | 1.9 | 11.3 | 10.8 | 2.0 | 75.9 | 2.0 | 0.0 | 0.5 | 0.8 | Water | 0.64 | 0.38 | 1.1 | 0.3 |
| | | | | | | | | | | | | atomization | | | | |
| No. 15 | Comparative | 73.9 | 2.3 | 10.9 | 11.1 | 1.9 | 76.2 | 1.9 | 0.0 | 0.5 | 1.2 | Water | 0.52 | 0.41 | 0.4 | 0.1 |
| | Example | | | | | | | | | | | atomization | | | | |
| No. 16 | Comparative | 74.1 | 2.0 | 11.1 | 10.8 | 2.0 | 76.1 | 2.0 | 0.0 | 0.5 | 0.9 | Water | 0.51 | 0.42 | 0.3 | 0.1 |
| | Example | | | | | | | | | | | atomization | | | | |
| No. 17 | Comparative | 73.5 | 2.5 | 11.2 | 10.6 | 2.2 | 76.0 | 2.2 | 0.0 | 0.5 | 0.1 | Water | 0.48 | 0.44 | 0.5 | 0.1 |
| | Example | | | | | | | | | | | atomization | | | | |

As is clear from Table 1, in the amorphous alloy soft magnetic powders of Examples, an intensity of the peak of the XANES spectrum and an intensity ratio of peaks of the radial distribution function are within predetermined ranges. In contrast, in the amorphous alloy soft magnetic powders in Comparative Examples, an intensity and an intensity ratio are out of the predetermined ranges.

### 6.2. Degree of Crystallization of Amorphous Alloy Soft Magnetic Powder

A degree of crystallization of the obtained amorphous alloy soft magnetic powder was measured by an X-ray diffractometer. Measurement results are shown in Table 2.

Further, FIG. 11 shows X-ray diffraction profiles obtained by an X-ray diffractometer for the amorphous alloy soft magnetic powders in Sample No. 1 (Example) and Sample No. 15 (Comparative Example). As shown in FIG. 11, in the X-ray diffraction profile obtained based on the amorphous alloy soft magnetic powder in Sample No. 1, no peak was observed, and it was found that sufficient amorphization was achieved. In contrast, in the X-ray diffraction profile obtained based on the amorphous alloy soft magnetic powder in Sample No. 15, a peak was observed, and it was found that crystallization occurred.

### 6.3. Powder Properties of Amorphous Alloy Soft Magnetic Powder

Next, particle size distribution measurement was performed on the amorphous alloy soft magnetic powders obtained in Examples and Comparative Examples. This measurement was performed by using a Microtrac HRA9320-X100, manufactured by Nikkiso Co., Ltd., i.e., a laser diffraction particle size distribution measuring device. Then, D10, D50, D90, and (D90−D10)/D50 were calculated. Calculation results are shown in Table 2.

An apparent density AD and a tap density TD of the amorphous alloy soft magnetic powder obtained in Examples and Comparative Examples were measured. A relative value of the tap density TD when the apparent density AD was set to 100, that is, a ratio of the tap density to the apparent density was calculated. Calculation results are shown in Table 2.

### 6.4. Coercive Force of Amorphous Alloy Soft Magnetic Powder

Coercive forces of the amorphous alloy soft magnetic powders obtained in Examples and Comparative Examples were measured. Measurement results are shown in Table 2.

### 6.5. Magnetic Permeability of Magnetic Element

A magnetic element was prepared based on the following preparation conditions using a dust core obtained in Examples and Comparative Examples.
Constituent material for conductive wire: Cu
Wire diameter of conductive wire: 0.6 mm
Winding number (during measurement of magnetic permeability): 7 turns
Winding number (during measurement of core loss): 36 turns on primary side and 36 turns on secondary side

Next, a magnetic permeability of the prepared magnetic element was measured at a frequency of 100 kHz using an impedance analyzer. Then, the obtained magnetic permeability was evaluated in light of the following evaluation criteria.
A: The magnetic permeability is 20 or more.
B: The magnetic permeability is 17 or more and less than 20.
C: The magnetic permeability is 14 or more and less than 17.
D: The magnetic permeability is less than 14.

Evaluation results are shown in Table 2.

TABLE 2

| | | Evaluation results for amorphous alloy soft magnetic powder and magnetic element | | | | | | | |
|---|---|---|---|---|---|---|---|---|---|
| | | | | | (D90 - | | Ratio of tap | | Magnetic |
| | | | | | D10)/ | Degree of | density to | Coercive | permeability |
| | | D10 | D50 | D90 | D50 | crystallization | apparent density | force | 100 kHz |
| Sample No. | | μm | μm | μm | — | % | — | Oe | — |
| No. 1 | Example | 9.0 | 23.0 | 49.0 | 1.74 | 30 | 109 | 1.0 | A |
| No. 2 | Example | 8.0 | 22.0 | 38.0 | 1.36 | 20 | 110 | 1.1 | B |
| No. 3 | Example | 9.5 | 35.2 | 57.1 | 1.35 | 20 | 112 | 1.2 | B |
| No. 4 | Example | 9.4 | 24.9 | 48.4 | 1.57 | 25 | 110 | 1.3 | A |
| No. 5 | Example | 11.3 | 29.7 | 56.2 | 1.51 | 25 | 109 | 1.3 | A |
| No. 6 | Example | 9.3 | 25.1 | 48.5 | 1.56 | 30 | 109 | 1.8 | A |
| No. 7 | Example | 8.3 | 22.4 | 40.9 | 1.46 | 20 | 113 | 2.2 | B |
| No. 8 | Example | 9.7 | 25.4 | 49.0 | 1.55 | 25 | 114 | 2.1 | B |
| No. 9 | Example | 9.1 | 26.8 | 50.4 | 1.54 | 25 | 113 | 2.0 | B |
| No. 10 | Example | 9.6 | 25.7 | 50.0 | 1.57 | 20 | 114 | 1.9 | B |
| No. 11 | Example | 9.1 | 24.1 | 49.7 | 1.68 | 30 | 118 | 2.0 | C |
| No. 12 | Example | 2.5 | 5.2 | 10.3 | 1.50 | 25 | 115 | 2.0 | A |
| No. 13 | Example | 2.0 | 4.6 | 9.4 | 1.61 | 30 | 118 | 2.1 | B |
| No. 14 | Example | 2.2 | 3.8 | 8.5 | 1.66 | 35 | 119 | 2.3 | C |
| No. 15 | Comparative | 1.2 | 4.8 | 12.0 | 2.25 | 80 | 117 | 4.2 | B |
| | Example | | | | | | | | |
| No. 16 | Comparative | 1.7 | 3.1 | 11.0 | 3.03 | 90 | 120 | 3.9 | C |
| | Example | | | | | | | | |
| No. 17 | Comparative | 1.9 | 3.4 | 10.5 | 2.57 | 80 | 122 | 4.5 | B |
| | Example | | | | | | | | |

As shown in Table 2, it is confirmed that amorphous alloy soft magnetic powders obtained in Examples have a higher magnetic permeability and a lower coercive force than the amorphous alloy soft magnetic powders obtained in Comparative Examples. It is confirmed that the amorphous alloy soft magnetic powder obtained in Examples have a lower degree of crystallization than the amorphous alloy soft magnetic powders obtained in Comparative Examples.

From the above, it is found that when results of the XAFS measurement satisfy the predetermined condition, an amorphous alloy soft magnetic powder is obtained in which sufficient amorphization is achieved and which achieves both a high magnetic permeability and a low coercive force.

It is also found that the magnetic permeability of the magnetic element can be increased by optimizing (D90−D10)/D50 and the ratio of the tap density to the apparent density.

Further, the content rate of P in the amorphous alloy soft magnetic powder in each Example is in the range of 0.0050 mass % or more and 0.0150 mass % or less, and the ratio S/P is in the range of 0.2 or more and 0.8 or less. In contrast, in the amorphous alloy soft magnetic powder in each Comparative Example, the ratio S/P is out of the range of 0.2 or more and 0.8 or less. It is considered that these trace elements also affect a difference in properties between Examples and Comparative Examples. Table 1 shows the ratio S/P for each Example and Comparative Example.

What is claimed is:

1. An amorphous alloy soft magnetic powder comprising:
a particle having a composition with a compositional formula (Fe₁₋ₓCrₓ)ₐ(Si_{1-y}B_{y})_{100-a-b}C_{b} expressed by an atomic ratio, in which
0<x≤0.06
0.3≤y≤0.7
70.0≤a≤81.0, and
0<b≤3.0, wherein
when XAFS measurement is performed on the particle with an analysis depth set to a bulk, an obtained Fe—K absorption edge XANES spectrum has a first absorption edge structure having a peak A having an energy in a range of 7113±1 eV and a first continuous band structure positioned at a higher energy side than the first absorption edge structure, and
an intensity of the peak A at an energy of 7113 eV is 0.60 or more and 0.90 or less when an intensity of the first continuous band structure is 1.

2. The amorphous alloy soft magnetic powder according to claim 1, wherein
when XAFS measurement is performed on the particle with an analysis depth set to a surface, an obtained Fe—K absorption edge XANES spectrum has a second absorption edge structure having a peak B having an energy in a range of 7113±1 eV and a second continuous band structure positioned at a higher energy side than the second absorption edge structure, and
an intensity of the peak B at an energy of 7113 eV is 0.10 or more and 0.38 or less when an intensity of the second continuous band structure is 1.

3. The amorphous alloy soft magnetic powder according to claim 1, wherein
a radial distribution function, which is obtained by performing XAFS measurement on the particle with an analysis depth set to a bulk to obtain an Fe—K absorption edge EXAFS spectrum and then performing Fourier transform on the Fe—K absorption edge EXAFS spectrum, has a peak C having an interatomic distance in a range of 0.10 nm or more and 0.14 nm or less, and a peak D having an interatomic distance in a range of 0.18 nm or more and 0.22 nm or less, and
an intensity ratio C/D is 0.7 or more where C is an intensity of the peak C and D is an intensity of the peak D.

4. The amorphous alloy soft magnetic powder according to claim 1, wherein
a radial distribution function, which is obtained by performing XAFS measurement on the particle with an analysis depth set to a surface to obtain an Fe—K absorption edge EXAFS spectrum and then performing Fourier transform on the Fe—K absorption edge EXAFS spectrum, has a peak E having an interatomic distance in a range of 0.10 nm or more and 0.14 nm or less, and a peak F having an interatomic distance in a range of 0.18 nm or more and 0.22 nm or less, and
an intensity ratio E/F is 0.20 or more and 0.70 or less where E is an intensity of the peak E and F is an intensity of the peak F.

5. The amorphous alloy soft magnetic powder according to claim 1, wherein
a magnetic permeability at a measurement frequency of 100 kHz is 20.0 or more, and
a coercive force is 24 A/m or more and 199 A/m or less, that is, 0.3 Oe or more and 2.5 Oe or less.

6. A dust core comprising:
the amorphous alloy soft magnetic powder according to claim 1.

7. A magnetic element comprising:
the dust core according to claim 6.

8. An electronic device comprising:
the magnetic element according to claim 7.
